(19) United States
(12) Patent Application Publication
(10) Pub. No.: US 2002/0119879 A1
(43) Pub. Date: Aug. 29, 2002

(54) Device for unfolding of folded boxes

(76) Inventors: Thomas Wyss, Lich (DE); Walter Baur, Gruendau (DE)

Correspondence Address: FLYNN, THIEL, BOUTELL & TANIS, P.C., 2026 Rambling Road, Kalamazoo, MI, 49008-1699, US

(21) Appl. No.: 10/081,140

(22) Filed: Feb. 22, 2002

(30) Foreign Application Priority Data
Feb. 23, 2001 (DE) 101 08 951.1

(51) Int. Cl. B31D 5/00

(52) U.S. Cl. 493/374

(57) ABSTRACT

A device for unfolding of folded boxes, comprising a magazine for receiving of flat folded-box sleeves, a removing device for the individual removal of the folded-box sleeves from the magazine and for feeding the folded-box sleeves to an unfolding station where the folded-box sleeves are partially unfolded along a compressing section. The unfolding device has after the compressing section a chute for the precisely fitting receipt of the partially unfolded folded-box sleeves, an output device to remove the folded-box sleeves from the chute, and an expansion chamber following the chute for receiving the fully unfolded folded-box sleeves in order to achieve a very high unfolding rate.

### FIELD OF THE INVENTION

The invention relates to a device for unfolding of folded boxes, comprising a magazine for receiving of flat folded-box sleeves, a removing device for the individual removal of the folded-box sleeves from the magazine and for feeding the folded-box sleeves to an unfolding device where the folded-box sleeves are unfolded along a compressing section.

### BACKGROUND OF THE INVENTION

Folded-box blanks made out of cardboard and glued to form sleeves are unfolded with such a device by applying a compressing pressure onto opposite edges of the folded-box sleeves. When unfolding a flat folded-box sleeve, its cross section is changed into a rectangle. The bottom-side face of the folded box is subsequently glued and closed off, the folded box is filled, for example, with a tubular bag, and finally the top-side face is glued and closed off.

Devices are known for unfolding the folded box fully through mechanical pressure along a compressing section, namely until right inner angles exist at all four edges of the folded-box sleeve. Only then is the folded-box sleeve moved on or further processed. The full unfolding, however, takes relatively long. This time requirement is disadvantageous for relatively quick packaging operations.

The purpose of the invention is to avoid a relatively long time for the full mechanical unfolding of a folded-box sleeve and yet achieve fully unfolded folded-box sleeves.

### SUMMARY OF THE INVENTION

The purpose is attained by providing a chute following the compressing section for the precisely fitting receipt of the folded-box sleeves which are only partially unfolded at the compressing section, which chute has an output device for removing the partially unfolded folded-box sleeves from the chute, and an expansion chamber following the chute to receive the fully unfolded folded-box sleeves.

The device of the invention has the advantage that a full mechanical unfolding along the compressing section is avoided so that the compressing operation occurs in a shortened time. The precisely fitting receipt in the chute serves, on the one hand, for the partially unfolded folded-box sleeves to be held for a specific time in their unfolded position in order to permit the sleeve material to compensate through suitable forces for the earlier quick unfolding and the related stresses. On the other hand, the chute prevents an independent, full unfolding of the folded-box sleeve, as it would be possible from the there existing material stress. The folded-box sleeves are, after leaving the chute, in a state which results in the expansion chamber in a full unfolding of the folded-box sleeves. The expansion chamber does not have any limitation corresponding to the boundary specified in the chute. Due to the relatively great time savings, since only a partial unfolding occurs along the compressing section, there results a time advantage for the last to occur full unfolding, which time advantage enables a very high unfolding rate (sleeves per second). This rate results from the inertia forces of the flat folded-box sleeves being subjected to a reduced sum of compressing forces along the compressing section. The operation of the chute is optimal in particular at a very high unfolding speed.

When the removing device has several arms each with a suction head, and the arms can be moved by a drive and a planetary gearing along a cycloidal path, it is then possible in a technically simple manner to remove at a top of the cycloidal path a flat folded-box sleeve by means of a suction head from the magazine, and to place same into the chute at another top. The partial unfolding through compressing can then occur along a curve of the cycloidal path along a curved slide surface adapted to the curve. One edge of the folded-box sleeve is hereby pressed against the slide surface.

When the output device has lugs, the lug surface of which corresponds with respect to its alignment to a sidewall of a partially unfolded folded-box sleeve, then the lug surface rests flat on the sidewall during the removal of the folded-box sleeve from the chute, thus does not press said sidewall in and does not influence the unfolding state of the folded-box sleeve.

A very good independent unfolding of the folded box in the expansion chamber occurs when the folded-box sleeve is still lacking 20 to 25 degrees until right angles on its inside are reached. A flat bearing of the lug surface on the sidewall is given for this case when a corresponding angle of 20 to 25 degrees is provided between the lug surface and a normal to a moving endless strand of the output device.

When a first device for forwarding of the fully unfolded folded-box sleeves is provided at the expansion chamber, it is then possible to feed with the device the folded-box sleeves from the expansion chamber to a filling and closing station. When the first device is driven at the same speed as a second device for forwarding, which second device follows the output device, it is then possible for the unfolded folded boxes to be forwarded in a reliable manner simultaneously by lugs of both devices. The forwarding occurs hereby in a careful manner when lugs of both devices hold the folded boxes at diagonally opposite edges of the folded boxes.

### BRIEF DESCRIPTION OF THE DRAWING

The invention will be described in greater detail in connection with one FIGURE, which illustrates one exemplary embodiment and shows:

FIGURE 1 is a top plan view of a device for unfolding folded boxes, comprising a three-arm removing device for the individual removal of flat folded-box sleeves from a magazine and for moving the folded-box sleeves along a curved slide surface in order to only partially unfold the folded-box sleeves, a chute to receive the incompletely unfolded folded-box sleeves, and an expansion chamber following the chute, in which expansion chamber the folded-box sleeves unfold automatically fully due to their internal stresses.

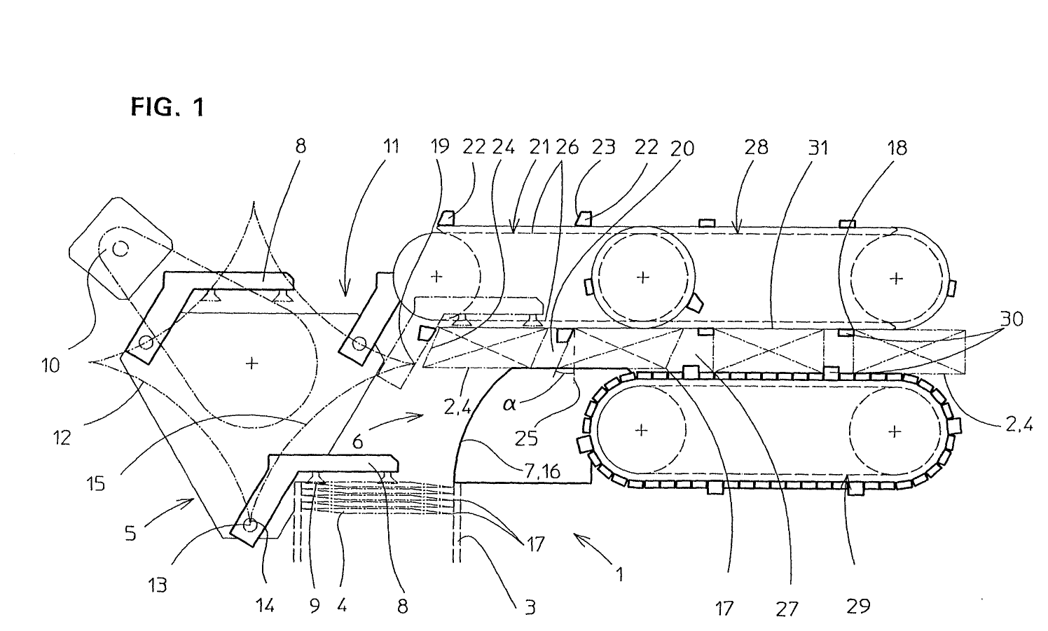

### DETAILED DESCRIPTION

A device 1 for unfolding of folded boxes 2 has a magazine 3, in which the prefolded, flat and closed folded-box sleeves 4 are stored. A removing device 5 is used to individually remove the folded-box sleeves 4 from the magazine 3 and to feed the folded-box sleeves 4 to an unfolding device 6 where the folded-box sleeves 4 are unfolded only partially initially along a compressing section 7.

The removing device 5 has three arms 8 each with suction heads 9. It is moved by a drive 10 and a planetary gearing 11 so that reference points 13 of the arms 8 describe a cycloidal path 12. One flat folded-box sleeve 4 is thereby removed from the magazine 3 starting at the point 14 of the cycloidal path 12. Along a curve 15 of the cycloidal path 12 occurs a partial unfolding of the flat folded-box sleeves 4 through compression on a curved slide surface 16 on which the folded-box sleeves 4 are moved along with pressure on one of the respective edges 17. A further point 19 of the cycloidal path 12 is provided at the end of this compressing section 7 in order to guide the folded-box sleeves 4 into a chute 20. The chute 20 provides for a precisely fitting receipt of the only partially unfolded folded-box sleeves 4.

The folded-box sleeves 4 keep their form in the chute 20 and reduce a part of the occurring stress. An output device 21 is provided to move the folded-box sleeves 4 through the chute 18. The output device 21 has lugs 22 each with a lug surface 23 inclined in the same direction as the sidewall 24 of the folded box 2 engaged therewith. An angle α of 22 degrees exists between the lug surface 23 and a normal 25 to a moving strand 26 of the output device 21.

An expansion chamber 27 follows the chute 20 to receive the partially unfolded-box sleeves 4, which unfold further threat due to the box sleeve's residual internal stress and become rectangular unfolded boxes 2. Two rotating devices 28, 29 are provided at the expansion chamber 27 to forward the fully unfolded folded-box sleeves 4. The output device 21 and these two devices 28, 29 hold the unfolded boxes 2 at diagonally opposite edges 17, 18 in order to forward the unfolded boxes 2 along a slide surface 31 to a filling and closing station.

### List of Reference Numerals

1 Device

2 folded box

3 magazine

4 folded-box sleeve

5 removing device

6 unfolding device

7 compressing section

8 arm

9 suction head

10 drive

11 planetary gearing

12 cycloidal path

13 reference point

14 point

15 curve

16 slide surface

17 edge

18 edge

19 point

20 chute

21 output device

22 lug

23 lug surface

24 sidewall

25 normal

26 strand

27 expansion chamber

28,29 device for forwarding

30 lug

31 slide surface

We claim:

1. A device for unfolding of folded boxes, comprising a magazine for receiving of flat folded-box sleeves, a removing device for the individual removal of the folded-box sleeves from the magazine and for feeding the folded-box sleeves to an unfolding device where the folded-box sleeves are unfolded along a compressing section, wherein the unfolding device has after the compressing section a chute for the precisely fitting receipt of the partially unfolded folded-box sleeves, an output device for removing the partially unfolded-box sleeves from the chute, and an expansion chamber following the chute for receiving the fully unfolded folded-box sleeves.

2. The device according to claim 1, wherein the removing device has several arms with a suction head, and the arms can be moved by a drive and a planetary gearing along a cycloidal path.

3. The device according to claim 1, wherein the compressing section is defined by a curved slide surface along which the folded-box sleeves can be moved.

4. The device according to claim 1, wherein the output device has lugs each with a lug surface configured to align with a sidewall of the partially unfolded folded-box sleeves.

5. The device according to claim 4, wherein an angle (α) in a range of 20 to 25 degrees is provided between each the lug surface and a normal to a strand of the output device.

6. The device according to claim 1, wherein a first device to forward the fully unfolded folded-box sleeves is provided at the expansion chamber.

7. The device according to claim 6, wherein the first device is operated at the same speed as a second device for the forwarding, which second device follows the output device.

8. The device according to claim 7, wherein lugs of the two devices hold the unfolded boxes at diagonally opposite edges of the unfolded boxes.
